(19) United States
(12) Patent Application Publication
(10) Pub. No.: US 2006/0238100 A1
(43) Pub. Date: Oct. 26, 2006

(54) Flat panel display

(76) Inventors: Motoyuki Miyata, Hitachinaka (JP); Osamu Shiono, Hitachi (JP); Yuichi Sawai, Mito (JP); Takashi Naitou, Mito (JP); Tatsuya Nagata, Ishioka (JP); Keiich Kanazawa, Ome (JP); Nobuhiko Hosotani, Mobara (JP); Yuichi Inoue, Mobara (JP); Hiroshi Ito, Chiba (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/401,222

(22) Filed: Apr. 11, 2006

(30) Foreign Application Priority Data
Apr. 20, 2005 (JP) 2005-122003

(51) Int. Cl. H01J 1/62

(52) U.S. Cl. 313/483

(57) ABSTRACT

The present invention has an object to provide a flat panel display which employs a high-strength glass material to realize a reduction in thickness and weight. The flat panel display includes two substrates SUB1 and SUB2 and a light emitter PMG provided between the two substrates. At least one of the two substrates is made of glass material containing SiO₂ as its main component and 1 to 20 wt % of at least one selected from La, Sc, Y, Ce, Pr, Nd, Pm, Sm, Eu, Gd, Tb, Dy, Ho, Er, Tm, Yb, and Lu.

### CROSS-REFERENCE TO RELATED APPLICATION

The present invention is related to (1) U.S. patent application Ser. No. 11/067,320 filed Feb. 14, 2005 entitled “FLAT-PANEL DISPLAY”, (2) U.S. patent application Ser. No. 11/293,211 filed Dec. 5, 2005 entitled “IMAGE DISPLAY APPARATUS”, (3) U.S. patent application Ser. No. 11/312,690 filed Dec. 21, 2005 entitled “IMAGE DISPLAY APPARATUS AND MANUFACTURING METHOD THEREOF”, (4) U.S. patent application Ser. No. 11/224,096 filed Sep. 13, 2005 entitled “GLASS MEMBER”, (5) U.S. patent application Ser. No. 11/224,095 filed Sep. 13, 2005 entitled “GLASS MEMBER AND PRODUCTION PROCESS THEREOF”, (6) U.S. patent application Ser. No. 11/205,176 filed Aug. 17, 2005 entitled “GLASS MEMBER”.

### FIELD OF THE INVENTION

The present invention relates to a flat panel display in which a flat-type display panel is used, known as a plasma display panel or a field emission display.

### BACKGROUND OF THE INVENTION

In flat panel displays (FPDs) employing flat-shaped display panels such as a plasma display panel (PDP) or a field emission display (FED), a glass material is often used as a component. For example, in the plasma display panel, a glass material is used for one substrate which forms a pixel selecting mechanism, the other substrate which provides a two-dimensional image displayed with a plurality of selected pixels, a frame material (sealing frame) which bonds the two substrates on their peripheries to form gas-filled space inside, and the like. In the field emission display, a glass material is used for one substrate which forms a pixel selecting mechanism, the other substrate which provides a two-dimensional image displayed with a plurality of selected pixels, a sealing frame (frame material) which bonds the two substrates on their peripheries to constitute a vacuum housing, and the like.

In the field emission display, a glass material is used not only for the abovementioned components but also for an interval holding member (spacer) which is erected and fixed to bridge the two substrates (back substrate and front substrate, and typically referred to as panel glasses) in order to hold the interval between the two substrates (panel glasses) at a predetermined value, and for a bonding material which bonds and fixes the respective components.

The abovementioned two substrates can be reduced in thickness to realize a weight reduction if the strength (physical strength such as resistance to breakage) is improved. Some displays have a filter glass disposed in front of the substrate on the side of an image display surface for ensuring resistance to breakage due to applied external force. If the strength of the panel glasses is increased, such a filter glass is not required, thereby achieving a lighter weight and preventing a lower quality of image due to multiple reflection.

The field emission display has a plurality of spacers erected between two panel glasses to maintain the interval between the substrates at a predetermined value. The spacers are also made of glass material. If the spacers have a higher strength, the number of the spacers to be provided can be reduced to result in a weight reduction.

### BRIEF SUMMARY OF THE INVENTION

It is contemplated that the flat panel display can be used as a wall-hung television which is inexpensive and easily installed. However, in a commercially available plasma display panel having a nominal size of 32 inches, for example, only its display portion weighs more than 20 kilograms. Installation of the display panel on a wall of an ordinary house or the like requires special work such as reinforcement of the wall. A reduction in weight and thickness of the flat panel display is also needed for the reason.

The panel glass for use in the display panel of the flat panel display requires high light transmittance, heat resistance, chemical stability, matching of the coefficient of thermal expansion with other members, and the like. In view of the required characteristics, it is impossible to use a glass material subjected to strengthening such as chemically tempered glass or crystallized glass. Thus, a certain thickness is necessary for ensuring a predetermined strength, which presents a problem in providing a thinner and lighter flat panel display.

For example, in the plasma display panel, the weight of the glass material used for the substrates and the like accounts for approximately one third of the total weight. To provide a more lightweight plasma display panel, thickness and weight of the glass material for the panel glass and the like needs to be reduced.

The field emission display requires the spacer, the sealing frame (also referred to as frame glass) for sealing the periphery to maintain the interior under vacuum, and the like, in addition to the glass substrates. These components need to have a higher strength.

It is an object of the present invention to provide a flat panel display in which a high-strength glass material is used for realizing a reduction in thickness and weight.

Other objects, features and advantages of the invention will become apparent from the following description of the embodiments of the invention taken in conjunction with the accompanying drawings.

### BRIEF DESCRIPTION OF THE DRAWINGS

FIG. 1 is a schematic diagram for explaining a display panel forming part of a typical flat panel display;

FIG. 2 is a schematic diagram showing a plasma display panel which is an example of the flat panel display;

FIG. 3 is a diagram for explaining the effect achieved by increasing the strength of a glass substrate;

FIGS. 4(a) and 4(b) are schematic diagrams for explaining reduced color mixing achieved by a thinner front substrate;

FIG. 5 is a graph showing the relationship between an imposed load and a crack occurrence rate in a glass material of the present invention, a glass material used in a current cathode-ray tube (CRT) and a plasma display panel (PDP), and a glass material used in a liquid crystal display (LCD);

FIG. 6 is a graph showing the relationship between a load at which the crack occurrence rate is 50% and a coefficient of thermal expansion in the glass materials described in FIG. 5;

FIG. 7 is a diagram for explaining the display principles of a single pixel in a panel forming part of a flat panel display using an MIM type electron source;

FIG. 8 is a schematic plan view for explaining an example of the overall structure of the flat panel display;

FIG. 9 is a partially cut perspective view for schematically explaining an example of the detailed overall structure of the flat panel display according to the present invention;

FIG. 10 is a section view taken along an A-A′ line of FIG. 9; and

FIG. 11 is a diagram for explaining an example of an equivalent circuit of the flat panel display.

### DESCRIPTION OF REFERENCE NUMERALS

PNL DISPLAY PANEL
PNL1 BACK PANEL
PNL2 FRONT PANEL
SUB1 ONE GLASS SUBSTRATE (BACK SUBSTRATE)
SUB2 OTHER GLASS SUBSTRATE (FRONT SUBSTRATE)
PMG IMAGING PORTION (LIGHT EMITTER)
DCT DRIVING CIRCUIT
PWU POWER UNIT
FLG FILTER GLASS
CAS CASE
PH(R), PH(G), PH(B) PHOSPHOR
BM LIGHT SHIED FILM (BLACK MATRIX)

### DETAILED DESCRIPTION OF THE INVENTION

To solve the abovementioned problem, the present invention provides a flat panel display fixed by providing space between two glass substrates (panel glass) forming a display panel, or a flat panel display including a filter glass disposed on the side of a display panel closer to a display surface, the display panel being formed of two glass substrates. The present invention is characterized by using a high-strength glass material containing a predetermined rear-earth element and having high resistance to breakage with low susceptibility to cracks for at least one of the components such as the glass substrate (panel glass), filter, spacer, and frame glass.

The present invention can provide the flat panel display in which a thin, lightweight, and high-strength glass material is used.

A preferred embodiment of the present invention will hereinafter be described in the following examples in detail.

### EXAMPLE 1

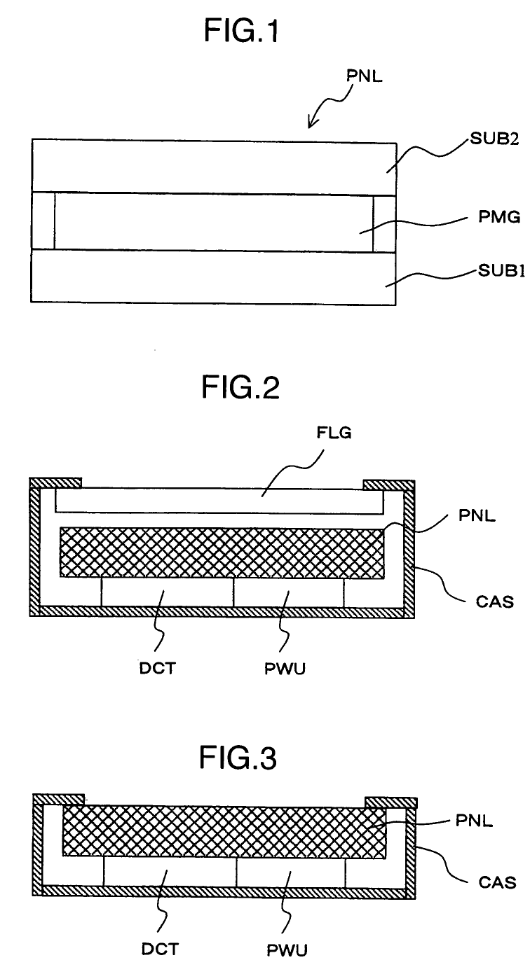

FIG. 1 is a schematic diagram for explaining a display panel which forms part of a typical flat panel display. The display panel PNL is formed of one glass substrate (back substrate) SUB1, the other glass substrate (front substrate) SUB2, and an imaging portion (light emitter) PMG sandwiched between the two substrates. FIG. 2 is a schematic diagram showing a plasma display panel which is an example of the flat panel display. The plasma display panel is formed of a display panel PNL, a driving circuit DCT, a power unit PWU, and a filter glass FLG disposed in front of the display panel PNL, all of which are accommodated by a case CAS.

In the plasma display panel of Example 1 (Embodiment 1), it is possible to reduce the thickness of the glass material used for the front substrate SUB2 and the back substrate SUB1 of the display panel PNL as compared with a conventional glass substrate (for example, having a thickness of 2.8 mm), resulting in a reduction in thickness and weight of the flat panel display.

A field emission display is formed of a front substrate, a back substrate disposed opposite thereto, a spacer disposed between the substrates, a frame glass (sealing frame) sandwiched between the substrates on their edges, and the like. With the use of the glass material of the present invention, the front substrate and the back substrate can be reduced in thickness and weight, similarly to the plasma display panel. It should be noted that a filter glass FLG may also be provided for the field emission display.

The spacer needs to have an extremely thin shape with a high aspect ratio of a height of approximately several millimeters and a width of several hundreds of micrometers, depending on the interval at which electron sources are formed. To use the glass material making up the spacer of such a shape stably for a long time period under reduced pressure where compressive stress is applied, the strength of the glass material itself should necessarily be increased. From the viewpoint, the material of the present invention having a higher strength than the conventional material as shown below is extremely effective as the spacer material.

FIG. 3 is a diagram for explaining the effect achieved by increasing the strength of the glass substrate. As shown in FIG. 3, the increased strength of the glass substrate allows the use of the structure with no need of the front filter glass in both of the plasma display panel and the field emission display to further reduce the thickness and weight of the flat panel display.

Even in the structure without the front filter glass, the glass material of Embodiment 1 can be used to form a layer for adjusting electrical characteristics or a layer for adjusting optical characteristics, which are currently provided for the front filter glass, in a front plate of the display panel. In case that the glass substrate is broken, a shatter-proof layer can be formed to prevent the broken glass from flying. A resin film is typically used for the shatter-proof layer.

Even when the front filter glass is necessary for some uses, the glass material of the present invention can be used for the front filter glass to reduce the thickness of the front filter glass, so that the resulting flat panel display can be thinner and more lightweight as a whole.

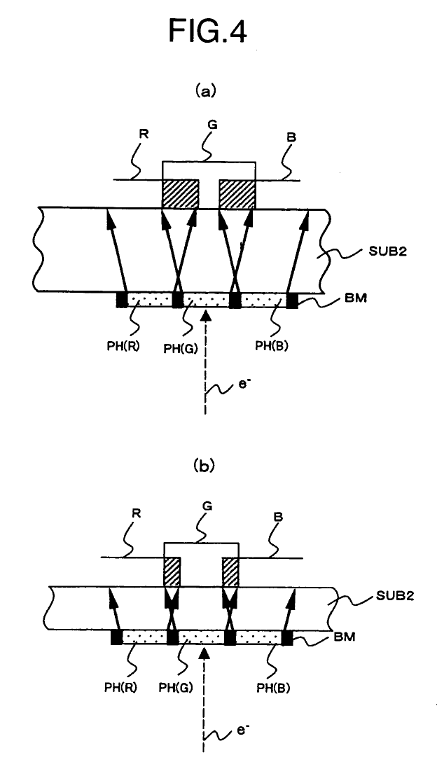

The advantages of the reduced thickness include not only the lighter weight as described above but also improvement in display performance of the flat panel display. FIGS. 4(a) and 4(b) are schematic diagrams for explaining reduced color mixing achieved by the thinner front substrate. FIG. 4(a) shows the display state before the front substrate SUB2 is reduced in thickness, while FIG. 4(b) shows the display state when the front substrate SUB2 is reduced in thickness. In FIGS. 4(a) and 4(b), phosphors PH(R), PH(G), and PH(B) for three colors (red, green, and blue) are applied on the surface of the front substrate SUB2 on the inner side such that they are defined by a black matrix film BM. The phosphors PH(R), PH(G), and PH(B) are covered with an anode, although not shown.

In FIG. 4(a), the phosphors PH(R), PH(G), and PH(B) are excited by an electron e⁻ hitting the front substrate SUB2 to emit light with respective color wavelengths. The emitted light passes through the front substrate SUB2 and then leaves the display surface. If the glass material making up the front substrate SUB2 has a large thickness, the light from the phosphor PH(G) crosses the light emitted from the adjacent phosphor(R) or PH(B), for example. FIG. 4(a) shows that crossing with hatching. As a result, color blurring (color mixing) occurs to reduce the color purity, that is, reduce the display quality.

In contrast, as shown in FIG. 4(b), the reduced thickness of the glass material making up the front substrate SUB2 can suppress the spreading of light emitted from the phosphor PH(R) or PH(B) and the area in which the color light crosses the other light. This can realize higher quality of the flat panel display, and the size of the phosphors can be reduced to achieve a higher resolution of a displayed image. The spreading of light emitted from the phosphor PH(R) or PH(B) and the area of the crossing are reduced depending on the refractive index and thickness of the glass material. Given the same refractive index, the spreading and the area of the crossing can be reduced to approximately half by using the glass material having a half thickness.

Next, the glass material of Embodiment 1 will be described. An actual large glass substrate for an image display having a size of one meter by one meter is manufactured, for example with a float method. In the following, description will be made for a method of making a prototype of the glass material for evaluating various characteristics thereof.

(Prototyping of Glass Material)

A predetermined amount of material powder was weighed and put in a crucible made of platinum, mixed, then melted in an electric furnace at a temperature of 1600° C. After the material was melted sufficiently, an agitating blade made of platinum was inserted into the melted glass and the glass was agitated for approximately 40 minutes. The agitating blade was removed and the glass was left at rest for 20 minutes. Then, the melted glass was poured into a jig made of graphite heated at approximately 400° C. and rapidly cooled to provide a glass block. The glass block was again heated to near a glass transition temperature of each glass and slowly cooled at a cooling rate of 1 to 2° C./min to remove distortion.

The process of distortion removal can be performed more slowly than usual to reduce distortion and further suppress the occurrence of cracks.

(Evaluation of Prototype of Glass Material)

The micro Vickers hardness (Hv) was measured at 10 points under the conditions of an imposed load of 500 grams and a loading time of 15 seconds, and the average was used. The measurement was made 20 minutes after the load was imposed. The test specimen was shaped to have a 4-by-4-by-15-milimeter size.

The rate of crack occurrence was measured under the same conditions as in the measurement of the micro Vickers hardness except the imposed load. The measurement was made within 30 seconds after the load was imposed.

The transmittance was measured from the ratio between the intensity of light incident perpendicular to the glass and the intensity of light after the transmission through the glass in a visible light wavelength range (380 to 770 nm) by using a spectrophotometer. The sample glass was shaped to have a 15-by-25-by-1-milimeter size.

(Glass Composition)

The components of the glass material of Embodiment 1 are as follows:

SiO2 as a main component, and at least one selected from La, Sc, Y, Ce, Pr, Nd, Pm, Sm, Eu, Gd, Tb, Dy, Ho, Er, Tm, Yb, and Lu.

The ratio of the abovementioned components is as shown in (1) or (2):

(1) in oxide conversion, SiO₂: 40 to 80 wt %, B₂O₃: 0 to 20 wt %, Al₂O₃: 0 to 30 wt %, R₂₀ (R is alkali metal): 5 to 20 wt %, R′O (R′ is alkaline earth metal): 0 to 25 wt %, and Ln₂O₃ (Ln is at least one selected from La, Sc, Y, Ce, Pr, Nd, Pm, Sm, Eu, Gd, Tb, Dy, Ho, Er, Tm, Yb, and Lu): 1 to 20 wt %;

(2) in oxide conversion, SiO₂: 50 to 70 wt %, B₂O₃: 0 to 15 wt %, Al₂O₃: 5 to 30 wt %, R₂₀ (R is alkali metal): 7 to 20 wt %, R′O (R′ is alkaline earth metal): 0 to 20 wt %, and Ln₂O₃ (Ln is at least one selected from La, Y, Gd, Yb, and Lu): 1 to 10 wt %.

A rare-earth oxide content of more than 20 wt % was not preferable since it reduced mechanical characteristics due to unmelting or heterogeneous glass. A content thereof of lower than 1 wt % provided an insufficient effect of improvement in mechanical strength. Thus, the rare-earth oxide content is preferably 1 to 20 wt %. Since a content of more than 10 wt % causes the glass material to start devitrification to reduce the light transmittance, the range of 1 to 10 wt % is more preferable.

Next, the composition of the glass material was examined. Since an SiO₂ content of lower than 40 wt % was not preferable since it reduced the mechanical strength and chemical stability. An SiO₂ content of more than 80 wt % reduced the melting property to cause much striae. From those facts, the SiO₂ content is preferably 40 to 80 wt %, and more preferably, 50 to 70 wt %.

When B₂O₃ was contained in the glass material, the resulting glass had excellent fluidity. However, a content thereof exceeding 20 wt % reduced the effect of an improved mechanical strength due to the contained rare earth. Thus, the B₂O₃ content is preferably 20 wt % or lower, and more preferably 15 wt % or lower. When both of B₂O₃ and alkali metal oxide are present, the vaporization of the alkali metal is promoted during glass melting to damage a wall material of the melting furnace or the like to cause an increase in cost, so that it is preferable not to use B₂O₃ and alkali metal oxide together, especially in the phase of mass production.

Next, the alkali metal oxide was examined. The total of the alkali metal oxide contents (Li₂O, Na₂O, and K₂O) exceeding 20 wt % reduced the chemical stability. Since the addition of the alkali metal oxides serves to increase the coefficient of thermal expansion of the glass material, the total of the alkali metal oxide contents is preferably 5 to 20 wt %, and more preferably 7 to 20 wt %.

For the alkaline earth metal oxide, a content of more than 25 wt % reduced the chemical stability. Similarly to the alkali metal oxide, the addition of the alkaline earth metal oxide also serves to increase the coefficient of thermal expansion of the glass material, and it does not reduce the transition point of the glass material unlike the alkali metal oxide. Thus, the alkaline earth metal oxide content is preferably 25 wt % or lower, and more preferably 20 wt % or lower.

The addition of two or more kinds of the alkaline earth metal such as SrO and BaO improved the resistance to electron irradiation. As a result, color changing and coloring of the glass are reduced when electrons are applied for a long time period. However, the addition thereof causes the glass to be brittle with a high crack occurrence rate, so that it is preferable to add an extremely small amount of them.

The alkali metal oxide and the alkali earth metal oxide had the same effects in terms of a reduced melting point of the glass. A total content of lower than 5 wt % showed poor fluidity and much striae. A total content of more than 40 wt % reduced the chemical stability. From those facts, the total of the alkali metal oxide and the alkali earth metal oxide contents is preferably 5 wt % or higher and less than 40 wt %.

Al₂O₃ is effective in increasing the mechanical strength and chemical stability of the glass, and those effects were significantly seen with the content of 5 wt % or higher. However, a content of more than 30 wt % was not preferable since the fluidity of the glass was reduced. Thus, the Al₂O₃ content is preferably 30 wt % or lower, and more preferably, 5 to 25 wt %.

Besides the abovementioned oxides, ZnO, ZrO₂ or the like can be added. The addition of ZnO effectively promotes the melting of the glass and improves the durability of the glass. Particularly, a content of 0.5 wt % or higher is preferable since the effects are significantly achieved. However, a content of more than 10 wt % increases the devitrification of the glass to cause the inability to provide homogeneous glass.

The addition of ZrO₂ effectively improves the durability of the glass. Particularly, a content of 0.5 to 5 wt % is preferable since the effect is more significantly achieved. However, a content of more than 5 wt % makes the melting of glass difficult and increases the devitrification of the glass.

Table 1 shows examples of the present invention. As shown, each glass of the present invention shows a load at which the crack occurrence rate is at 50% of more than 5000 mN, a transition point of 450° C. or higher, and a coefficient of thermal expansion of 60 to 90×10⁻⁷/° C.

TABLE 1

| | | | | | | | | | | | | | | | | Load for |
|---|---|---|---|---|---|---|---|---|---|---|---|---|---|---|---|---|
| | | | | | | | | | | | | | | | | crack |
| | | | | | | | | | | | | | | Transition | α(×10⁻⁷/ | occurrence |
| | Composition (wt %) | | | | | | | | | | | | | point | ° C.) | 50% |
| | SiO2 | B2O3 | Al2O3 | Na2O | Li2O | K2O | Gd2O3 | ZnO | SrO | BaO | MgO | CaO | ZrO2 | (° C.) | (30˜350° C.) | (mN) |
| Example 1 | 67.0 | 1.0 | 15.0 | 9.0 | 3.0 | 2.0 | 3.0 | | | | | | | 498 | 86 | 20000 |
| Example 2 | 67.0 | | 15.0 | 8.0 | 4.0 | 1.0 | 3.0 | 2.0 | | | | | | 493 | 81 | 21000 |
| Example 3 | 59.0 | 8.2 | 13.9 | 7.6 | 4.3 | 2.2 | 5.0 | | | | | | | 492 | 78 | 21500 |
| Example 4 | 65.0 | | 16.0 | 4.0 | 9.0 | 1.0 | 3.0 | 2.0 | | | | | | 467 | 86 | 23000 |
| Example 5 | 63.0 | | 15.0 | 9.0 | 2.0 | 2.0 | 7.0 | 2.0 | | | | | | 532 | 81 | 21000 |
| Example 6 | 58.0 | 10.0 | 15.0 | 6.5 | 3.5 | 2.0 | 3.0 | 2.0 | | | | | | 515 | 82 | 21000 |
| Example 7 | 65.0 | 2.0 | 15.0 | 9.0 | 2.0 | 2.0 | 5.0 | | | | | | | 534 | 76 | 20500 |
| Example 8 | 65.0 | 1.0 | 14.0 | 9.0 | 0.0 | 2.0 | 3.0 | | 2.0 | 1.0 | 3.0 | | | 548 | 82 | 16500 |
| Example 9 | 65.0 | | 14.0 | 8.0 | 0.0 | 1.0 | 3.0 | 2.0 | 2.0 | 1.0 | 4.0 | | | 543 | 77 | 17000 |
| Example 10 | 58.0 | 8.2 | 13.9 | 7.6 | 0.0 | 2.2 | 3.0 | | 2.0 | 1.0 | 4.3 | | | 542 | 74 | 18000 |
| Example 11 | 63.0 | | 15.0 | 4.0 | 5.0 | 1.0 | 3.0 | 2.0 | 2.0 | 1.0 | 4.0 | | | 517 | 82 | 19500 |
| Example 12 | 65.0 | | 14.0 | 9.0 | 0.0 | 2.0 | 3.0 | 2.0 | 2.0 | 1.0 | 2.0 | | | 582 | 77 | 17500 |
| Example 13 | 56.0 | 10.0 | 14.0 | 6.5 | 0.0 | 2.0 | 3.0 | 2.0 | 2.0 | 1.0 | 3.5 | | | 565 | 78 | 17500 |
| Example 14 | 65.0 | 2.0 | 14.0 | 9.0 | 0.0 | 2.0 | 3.0 | | 2.0 | 1.0 | 2.0 | | | 584 | 73 | 17000 |
| Example 15 | 64.0 | 1.0 | 10.0 | 3.0 | 0.0 | 2.0 | 3.0 | | 3.0 | 5.0 | 5.0 | 4.0 | | 578 | 78 | 12500 |
| Example 16 | 63.0 | 3.0 | 7.0 | 3.0 | 0.0 | 2.0 | 3.0 | 2.0 | 4.0 | 5.0 | 4.0 | 4.0 | | 577 | 74 | 13000 |
| Example 17 | 57.0 | 8.2 | 9.5 | 3.0 | 0.0 | 2.2 | 3.0 | | 4.3 | 4.9 | 4.6 | 3.0 | 0.5 | 572 | 71 | 14000 |
| Example 18 | 57.0 | 4.0 | 9.0 | 3.0 | 0.0 | 2.0 | 3.0 | 2.0 | 9.0 | 6.0 | 2.0 | 2.0 | 1.0 | 553 | 79 | 13500 |
| Example 19 | 57.0 | 7.0 | 10.0 | 3.0 | 0.0 | 2.0 | 3.0 | 2.0 | 2.0 | 5.0 | 4.0 | 5.0 | | 614 | 74 | 13500 |
| Example 20 | 55.0 | 10.0 | 10.0 | 3.0 | 0.0 | 2.0 | 3.0 | 2.0 | 3.5 | 5.0 | 3.5 | 3.0 | | 607 | 75 | 13500 |
| Example 21 | 64.0 | 2.0 | 10.0 | 3.0 | 0.0 | 2.0 | 3.0 | | 2.0 | 5.0 | 4.0 | 5.0 | | 618 | 72 | 13000 |
| Comparative | 63.0 | | 3.0 | 2.0 | | ### | | | 11.0 | 1.0 | 6.5 | 3.5 | | 613 | 79 | 2000 |
| example 1 | | | | | | | | | | | | | | | | |
| Comparative | 60.0 | | 7.0 | 4.0 | | 6.0 | | | 7.0 | 7.0 | 2.0 | 4.5 | 2.5 | 598 | 75 | 2300 |
| example 2 | | | | | | | | | | | | | | | | |
| Comparative | 62.0 | | 2.5 | 7.8 | | 7.5 | | | 8.0 | 9.0 | 0.2 | 0.6 | 1.8 | 495 | 102 | 1800 |
| example 3 | | | | | | | | | | | | | | | | |
| Comparative | 56.0 | 6.0 | 11.0 | | | | | | 7.0 | 15.0 | 2.0 | 3.0 | | 647 | 47 | 12000 |
| example 4 | | | | | | | | | | | | | | | | |

(Effect of Surface Treatment)

In the glass material of the present invention, the end face on the outer edge and the chamfered surface are preferably etched with hydrofluoric acid, fluoro-nitric acid, fluoro-sulfuric acid, buffered hydrofluoric acid or the like in order to remove small flaws due to the processing. The treatment can improve a bending strength by at least approximately 30%. Especially when the etching is performed on the glass containing the rare-earth oxide as the glass component, a significantly high strength can be realized.

(Comparison with Surface Strengthened Glass)

The glass material of the present invention provides a sufficient strength by the addition of the rare-earth element. Thus, it does not require surface strengthening such as chemical strengthening which is a conventional strengthening method for glass materials. In other words, it is characterized by eliminating a compressive strengthening layer in which residual stress is produced on a glass surface. The presence or absence of the compressive strengthening layer on the surface can be measured, for example, by applying a laser beam to the surface to perform spectral observations of the light reflected thereby with a prism. The measurement of the glass material of the present invention with the abovementioned method revealed almost no difference in residual stress between the interior and surface of the glass material, that is, no presence of a surface stress layer.

The glass material of Embodiment 1 is characterized by having no compressive strengthening layer on its surface to provide substantially uniform distribution of stress inside the glass. As a result, even when the surface of the glass of Embodiment 1 is flawed at substantially the same depth as the compressive strengthening layer of chemically tempered glass, the glass of Embodiment 1 is not broken into pieces unlike the chemically tempered glass.

Since the chemically tempered glass has the compressive strengthening layer on the surface and the tensile layer inside for balancing, the thickness is disadvantageously limited depending on a predetermined strength which should be provided. In contrast, the glass material of Embodiment 1 does not need the surface stress layer, so that no limitation is imposed on the thickness unlike the chemically tempered glass to enable a thinner glass to be formed. While the conventional glass substrate requires a thickness of approximately 2.8 mm to ensure the mechanical strength, the glass of Embodiment 1 can be used to form a thinner glass substrate than the conventional glass material since the glass material of Embodiment 1 is strengthened without performing special strengthening, thereby enabling a reduction in thickness and weight of the flat panel display.

(Characteristics of Glass)

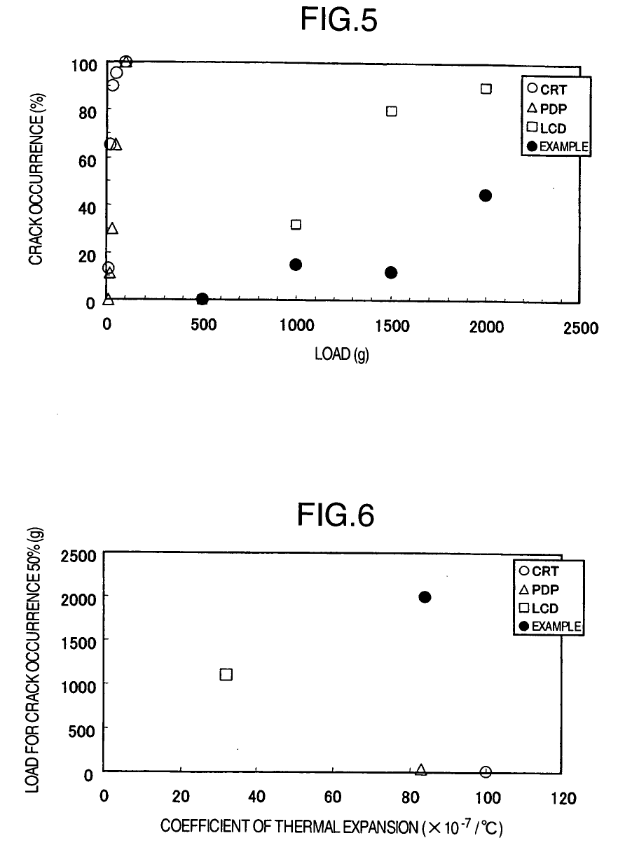

FIG. 5 is a graph showing the relationship between an imposed load and a crack occurrence rate in the glass material of Embodiment 1 of the present invention, a glass material used in a current cathode-ray tube (CRT) and a plasma display panel (PDP), and a glass material used in a liquid crystal display (LCD). It shows that the glass materials used in the current CRT and PDP have a crack occurrence rate of 100% at an imposed load of approximately 100 g, while the glass material of Embodiment 1 has a crack occurrence rate of approximately 50% at an imposed load of 2000 g and thus has extremely higher resistance to cracks as compared with the current CRT and PDP. The material used in the current LCD shows a crack occurrence characteristic which is more favorable than the glass material for the PDP but is somewhat poorer than the glass material of Embodiment 1.

FIG. 6 is a graph showing the relationship between a load at which the crack occurrence rate is 50% and a coefficient of thermal expansion in the glass materials described in FIG. 5. As shown in FIG. 6, the glass material of Embodiment 1 has substantially the same coefficient of thermal expansion as the glass material of the current CRT and PDP and shows an extremely higher value of the load at which the crack occurrence rate is 50% as compared with the glass material for the current CRT and PDP. The glass material for the LCD, which showed the more favorable crack characteristic than the glass material for the current CRT and PDP, has a coefficient of thermal expansion which is smaller than that of the PDP or FED and does not satisfy the thermal expansion characteristic required in the glass material for the flat panel display.

In the display panel of Embodiment 1 and the flat panel display using the same, the glass material making up the glass substrate can be reduced in thickness, which can reduce the weight of the glass material and thus the weights of the display panel and the flat panel display. On the other hand, a higher density of the glass material reduces the effect of the weight reduction resulting from the reduced thickness of the glass substrate. Thus, the density of the glass material is preferably 2.8 g/cm³ or lower, and more preferably, 2.6 g/cm³ or lower.

The transition point of the glass material of Embodiment 1 is preferably 450° C. or higher, and more preferably, 600° C. or higher. This is specified for the following reason. The display panel is subjected to heat treatment which involves heating to a high temperature in a bonding step or an evacuation step during the process of manufacturing. If the transition point of the glass material is lower than the highest temperature in the heat treatment step performed or assumed during the process of manufacturing the display panel, residual stress is produced in the glass substrate to cause a failure or breakage of the display panel.

The coefficient of thermal expansion of the glass material of Embodiment 1 is preferably 60 to 90×10⁻⁷/° C., and more preferably, 70 to 90×10⁻⁷/° C. in view of the coefficient of thermal expansion of the other members such as the sealing glass material. This is because a smaller or larger coefficient of thermal expansion produces residual stress near the junction due to the difference in coefficient of thermal expansion to cause a failure or breakage of the panel.

The Young's modulus and the relative elastic modulus (value of the Young's modulus divided by the density) of the glass material of Embodiment 1 are preferably 80 Gpa and 30 Gpa/(g/cm³) or higher, respectively. This is because a smaller Young's modulus and a smaller relative elastic modulus increase a warp of the glass substrate as compared with the current material to reduce the handleability, causing a failure in the manufacture process and a reduced yield.

Since Embodiment 1 enables the thickness of the glass substrate to be reduced without significantly changing the density of the glass material as compared with the conventional glass substrate material, a reduction in thickness and weight can be expected in the flat panel display. In addition, the lighter weight of the flat panel display can presumably reduce cumbersome tasks in carrying and installing the display as well as the cost. The flat panel display can be directly set on a wall or the like.

For the current plasma display panel, the glass material accounts for approximately 35% of the weight of the monitor portion (image display portion). The thinner glass substrate can lower the percentage and reduce the weight of the display.

When the thickness of the glass substrate is reduced, a thickness of 2.5 mm corresponds to approximately 21% of the current glass substrate and can reduce the weight of the (two) glass substrates by 20% or more, and a thickness of 1.5 mm can reduce the weight more greatly. Thus, the thickness of the glass material is preferably 2.5 mm or less, and more preferably, 1.5 mm or less.

Since the glass material of Embodiment 1 can be used to form glass sheets each having a small thickness in view of the strengthening mechanism, two or more sheets of glasses may be laminated with a resin film disposed between them to further enhance the strength for uses which require a particularly high strength. Such a laminated glass can be used for the front filter to further improve the reliability of the flat panel display. However, the total weight of the glass sheets is increased in proportion to the number of laminated sheets, so that the total thickness of the laminated glass sheets is desirably equal to or smaller than the single sheet material to avoid an excessive weight.

For the laminated glass material, its strength can be further increased by disposing wire made of metal, ceramic, carbon fiber, glass fiber or the like within the resin layer in laminating the glass.

To provide the wire within the glass material, wire made of metal, ceramic or the like may be disposed within the glass. In this case, while the molten raw material of the glass is at high temperature, wire made of heat-resistant metal, ceramic or the like can be inserted, cooled, and solidified to provide a glass plate with the wire contained therein. It is expected that the inclusion of the wire in the transparent glass can prevent pieces of the glass from falling and flying at collision of a heavy object. Such a glass material is particularly preferable for the flat pane display which is placed outdoors.

The glass material of Embodiment 1 can be colored by containing various elements. The elements for coloring include not only rare-earth elements but also iron, cobalt, nickel, chromium, manganese, vanadium, selenium, copper, gold, silver, and the like. An appropriate amount of these elements can be added for required uses to color the glass material to improve the contrast in the flat panel display.

For water resistance, the glass material of Embodiment 1 involved a smaller amount of eluted alkali to show favorable chemical stability as compared with the chemically tempered glass. In a test of heat resistance, a large amount of alkali element was detected on the surface layer of the chemically tempered glass to show ion movement. Such a phenomenon, however, was not seen in the glass material of Embodiment 1.

As described above, while the chemically tempered glass was unstable with the ease of movement of the alkali element, the glass material of the present invention had excellent thermal and chemical stability.

For the surface roughness, the glass material of Embodiment 1 provided satisfactory smoothness with a surface roughness Ra=0.1 to 0.3 nm. The surface roughness after the water resistance test also showed favorable smoothness with a surface roughness Ra=0.2 to 0.4 nm. On the other hand, the chemically tempered glass showed Ra=0.9 nm, and a large value of Ra=1.5 after the water resistance test. In addition, the glass material of Embodiment 1 provided a favorable result as compared with the glass material which contained no rare-earth oxide. In this manner, the glass material of Embodiment 1 is excellent in chemical stability. Even when a transparent conductive film or an anti-reflection film is formed on the glass material, the films have favorable stability over time.

Next, a high-temperature and moisture-resistance test was performed in order to simulate long-term weatherability of the glass substrate. The glass material of Embodiment 1 and a conventional chemically tempered glass as a comparative example were put in the same environments at a temperature of 85° C. and humidity of 85% to observe any change. While the chemically tempered glass as the comparative example showed whitening on the surface 500 hours after the start of the test, the glass material of the present invention showed no particular change.

It is considered that the whitening on the surface is created by the alkali element within the glass material moving to the glass surface due to the humidity around it or the like and precipitating there. The whitening produced in the glass material making up the glass substrate on the display side reduces the quality of a displayed image. It is contemplated that the whitening easily occurs in the chemically tempered glass since the alkali element within the glass material is readily moved to the glass material surface. On the other hand, it is expected that the glass material of Embodiment 1 does not easily involve the whitening and accordingly has higher weatherability since the alkali element in the glass material is not readily moved to the glass material surface.

As shown in FIG. 3 described above, the structure without the front filter glass has, on the front substrate of the display panel, the layer for adjusting the electrical characteristics, the layer for the optical characteristics, and the shatter-proof layer for preventing broken glass from flying in case that the glass substrate is broken. Since the glass material of Embodiment 1 has the alkali component not easily moved to the glass material surface as described above and is chemically stable, the abovementioned layers formed on the surface of the glass material are not readily stripped or hardly reduce the performance.

When the flat panel display is installed outdoors, it is feared that crud naturally sticks to the surface due to the placement outdoors for a long time period to cause a reduction in quality of image display. A photocatalytic layer formed on the surface of the glass substrate allows optical energy to dissolve the crud stuck to the glass surface. Together with the cleaning effect in rain, the surface is easily maintained clean to result in prevention of the reduced quality of image display.

When the conventional, chemically tempered glass is used, the alkali element is moved from inside the glass material to easily strip the photocatalytic layer. On the other hand, the glass material of Embodiment 1 has the alkali element within the glass material not easily moved to the surface of the glass material and allows a reduction in the amount of alkaline elution to one fifth or smaller as compared with the chemically tempered glass material. Thus, the photocatalytic layer is not easily stripped. The glass material of Embodiment 1 can be readily maintained for a time period five times or more longer than that in the chemically tempered glass.

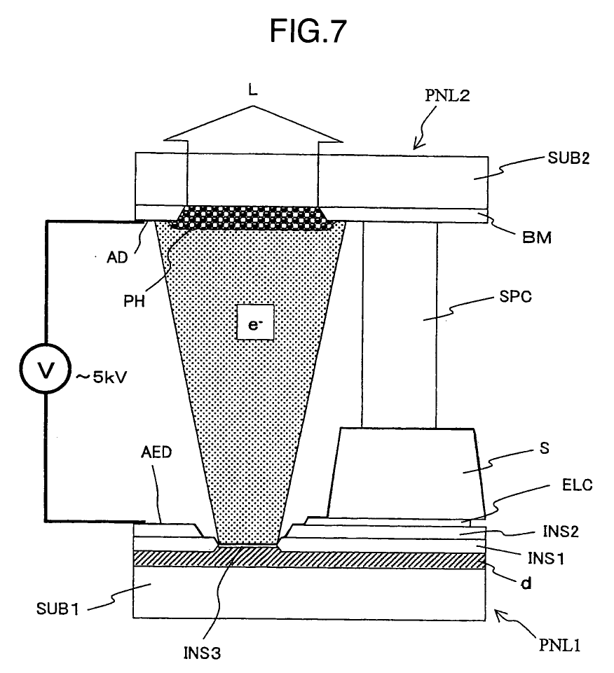

FIG. 7 is a diagram for explaining the display principles of a single pixel in a panel forming part of the flat panel display using an MIM type electron source. The panel includes a back panel PNL formed of a back substrate SUB1 and a front panel PNL2 formed of a front substrate SUB2, both of which are bonded together by a sealing frame or frame glass, not shown, to maintain the internal space under vacuum. The back panel PNL1 has, on a main surface (surface on the inner side) of the back substrate SUB1 made of the glass material according to the present invention, an image signal wiring (so-called data line) d which is preferably made of aluminum AL film and serves as a lower electrode of the electron source, a first insulator film INS1 (so-called tunnel insulator film or electron accelerating layer) made of anodized film provided by performing anodic oxidization of the aluminum of the lower electrode, a second insulator film INS2 preferably made of silicon nitride film SiN, a power electrode (connecting electrode for connecting an upper electrode, later described, to a scanning signal wiring s) ELC, the scanning signal wiring s preferably made of aluminum Al, and the upper electrode AED forming part of the electron source of the pixel connected to the scanning signal wiring s.

The electron source is formed of the image signal wiring d as the lower electrode, a thin film portion INS3 forming part of the first insulator film INS1 positioned on the upper electrode, and part of the upper electrode AED put as the layer above the thin film portion INS3. The upper electrode AED is formed to cover the scanning signal wiring s and part of the power electrode ELC. The thin film potion INS3 corresponds to the abovementioned tunnel film. These structures form a so-called diode electron source.

On the other hand, the front panel PNL2 has, on a main surface of the front substrate SUB2 preferably formed of a transparent glass substrate, a phosphor PH separated from an adjacent pixel by a light shield film (black matrix) BM and an anode AD preferably made of aluminum-evaporated film.

The back panel PNL1 and the front panel PNL2 are disposed with an interval of approximately 3 mm to 5 mm between them, and a spacer SPC maintains the interval. While FIG. 7 exaggerates the thickness of each constituent layer for ease of understanding, the thickness of the scanning signal wiring s is 3 micrometers, for example.

In the structure as described above, when an accelerating voltage (approximately 2, 3 kV to 10 kV, and approximately 5 kV in FIG. 7) is applied between the upper electrode AED of the back panel PNL1 and the anode AD of the front panel PNL2, an electron e− is emitted in accordance with the size of display data supplied to the image signal wiring d serving as the lower electrode, hits the phosphor PH with the accelerating voltage, and excites the phosphor PH to emit light L at a predetermined frequency (light emission frequency of the phosphor PH) outside the front panel PNL2. For full-color display, the unit pixel is a subpixel of a color, and typically, three subpixels for red (R), green (G), and blue (B) constitute a pixel for one color.

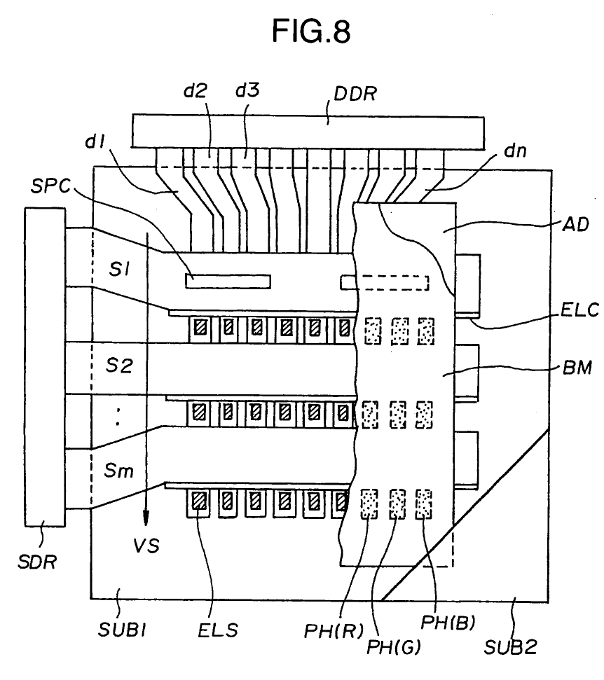

FIG. 8 is a schematic plan view for explaining an example of the overall structure of the flat panel display. Image signal wirings d (d1, d2, . . . , dn) are formed on the inner surface of the back substrate SUB1 forming the back panel, and scanning signal wirings s (s1, s2, s3, . . . , sn) are formed thereon to intersect. In FIG. 8, a spacer SPC is formed on the scanning signal wiring s1, and an electron source ELS disposed on the image signal wiring d is supplied with current from the scanning signal wirings s (s1, s2, s3, . . . , sn) through a connecting electrode ELC.

An anode AD is provided to cover phosphors PH (PH(R), PH(G), and PH(B)) for three colors formed on the inner surface of the front substrate SUB2 forming the front panel. The phosphors PH(PH(R), PH(G), and PH(B)) for three colors may be formed below the anode AD. The phosphors PH(PH(R), PH(G), and PH(B)) are defined by a light shield layer (black matrix) BM.

While the anode AD is shown as a solid electrode, it is possible to use a stripe-shaped electrode which is divided for each pixel column and intersects with the scanning signal wirings s (s1, s2, s3, . . . , sn). The electron radiated from the electron source is accelerated to hit the phosphor layer PH (PH(R), PH(G), or PH(B)) forming the associated subpixel. Thus, the phosphor layer PH emits light in a predetermined color which is mixed with a color of light from the phosphor of another subpixel to form a color pixel in a predetermined color.

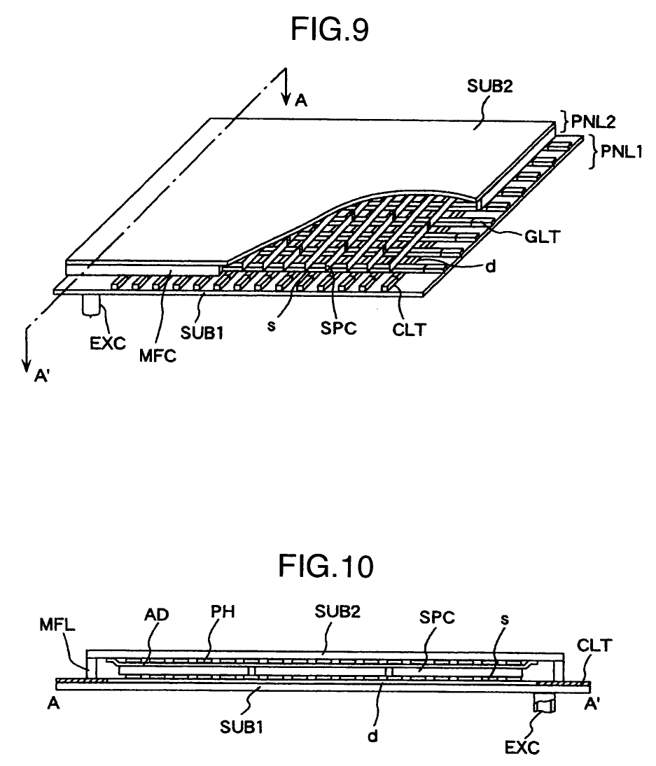

FIG. 9 is a partially cut perspective view for schematically explaining an example of the detailed overall structure of the flat panel display according to the present invention. FIG. 10 is a section view taken along an A-A′ line of FIG. 9. While the flat panel display is a display employing the MIM type electron source, the same structure is used in a different flat panel display including a thin film type cathode or the like. A back substrate SUB1 has an image signal wiring d and a scanning signal wiring d formed on its inner surface, in which an electron source is formed at each of intersections between the image signal wiring d and the scanning signal wiring s, thereby forming a back panel PNL1 as a whole.

An image signal wiring lead CLT is formed at the end of the image signal wiring d, while a scanning signal wiring lead GLT is formed at the end of the scanning signal wiring s. The image signal wiring lead CLT is connected to an image signal line driving circuit (data driver), not shown, while the scanning signal wiring lead GLT is connected to a scanning signal line driving circuit (scan driver), not shown.

An anode AD and a phosphor layer PH are formed on the inner surface of a front substrate SUB2 to form a front panel PNL2 as a whole. The back substrate SUB1 and the front substrate SUB2 are bonded together with a sealing frame (frame glass) MFL interposed between them on their edges. A spacer SPC preferably made of glass plate is erected between the bonded back substrate SUB1 and the front substrate SUB2 in order to hold the interval between the substrates at a predetermined value. FIG. 10 is a section along the spacer SPC and shows three spacers SPC disposed on the scanning signal wirings s, but an actual device is not limited thereto.

In general, the spacer SPC is formed of a flat and strip-shaped rectangular plate erected substantially perpendicular to the screen in order to reduce the number of spacers to simplify the manufacturing process and to support the overall display screen. The section of the spacer SPC cut perpendicularly along the longitudinal direction of the flat and strip-shaped plate typically has a shape having four corners, that is, an elongated rectangular. However, a shape having more than four corners may be used. For example, the section along the longitudinal direction may be a hexagon, an octagon, or a polygon having more corners. An ellipse may be used. The spacer SPC can have an aspect ratio of lower than 100 between a longer axis and a shorter axis of the section along the longitudinal direction since it allows an increased strength of the glass material.

The inner space sealed by the back panel PNL1, the front panel PNL2, and the frame glass MFL is evacuated from an evacuation pipe EXC provided for part of the back panel PNL1 and held in a predetermined vacuum state. The frame glass MFL may have all the frame sides integrally formed.

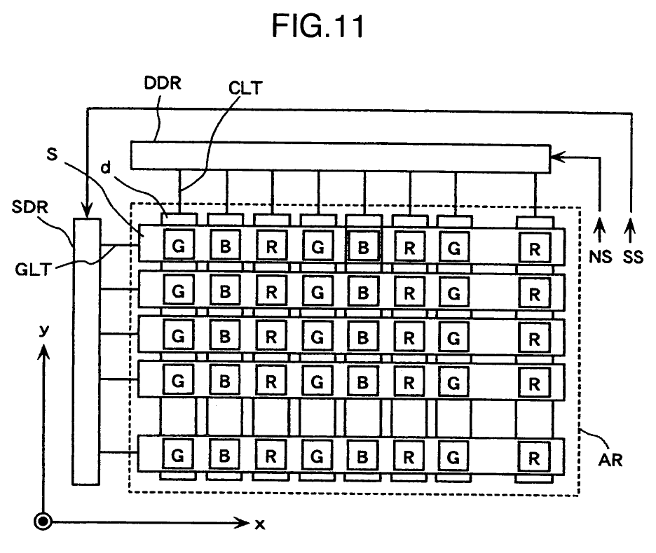

FIG. 11 is a diagram for explaining an example of an equivalent circuit of the flat panel display. An area shown by a broken line in FIG. 11 is a display area AR in which n pixel signal wirings d and m scanning signal wirings s are disposed to intersect with each other to form an n by m matrix. Each intersection in the matrix forms a subpixel and corresponds one of three unit pixels or subpixels in FIG. 11 (a group of “R,” “G,” and “B” make up a pixel for one color). The structure of the electron source and the spacer are not omitted in FIG. 11. The image signal wiring d is connected to a data driver DDR through an image signal wiring lead terminal CLT, while a scanning signal wiring lead terminal GLT is connected to a scan driver SDR. The data driver DDR is supplied with a display signal NS from an external signal source, while the scan driver SDR is supplied with a scanning signal SS.

Thus, the display signal (image signal or the like) can be supplied to the image signal wiring d intersecting with the sequentially selected scanning signal wirings s to display a two-dimensional full-color image. The use of the display in the example realizes the high-efficient image display of light-emitting flat type at a relatively low voltage.

The glass material of the present invention is not limited to the components such as the front substrate, back substrate, spacer, frame glass, and the surface filter glass in the abovementioned flat panel display such as the FED and PDP, and is applicable to a protection glass material for photovoltaic power generation panels, a windowpane for construction materials, a windowpane for vehicles, a glass substrate for HDDs, as well as structures employing various glass materials, mechanical tools, and various instruments and tools for daily use.

It should be further understood by those skilled in the art that although the foregoing description has been made on embodiments of the invention, the invention is not limited thereto and various changes and modifications may be made without departing from the spirit of the invention and the scope of the appended claims.

1. A flat panel display comprising at least two substrates and a space portion formed by said two substrates,
wherein at least one of said two substrates is made of glass material containing SiO₂ as its main component and 1 to 20 wt % of at least one selected from La, Sc, Y, Ce, Pr, Nd, Pm, Sm, Eu, Gd, Tb, Dy, Ho, Er, Tm, Yb, and Lu.

2. The flat panel display according to claim 1, wherein at least one of said two substrates is made of glass material containing SiO₂ as its main component and 1 to 20 wt % of at least one selected from La, Y, Gd, Yb, and Lu, and showing a load, at which a crack occurrence rate is 50%, of 5000 mN or higher.

3. A flat panel display comprising a display panel including at least two substrates and a space portion formed by said two substrates, and a filter glass disposed on the side of said display panel closer to a display surface,
wherein said filter glass is made of glass material containing SiO₂ as its main component and 1 to 20 wt % of at least one selected from La, Sc, Y, Ce, Pr, Nd, Pm, Sm, Eu, Gd, Tb, Dy, Ho, Er, Tm, Yb, and Lu.

4. The flat panel display according to claim 3, wherein said filter glass is made of glass material containing SiO₂ as its main component and 1 to 20 wt % of at least one selected from La, Y, Gd, Yb, and Lu, and showing a load, at which a crack occurrence rate is 50%, of 5000 mN or higher.

5. The flat panel display according to claim 3, wherein said filter glass is made of laminated material provided by laminating two or more sheets of glass material with a bonding layer.

6. The flat panel display according to claim 1, wherein said two substrates are a back substrate having on its inner surface an electron source array, and a front substrate having on its inner surface a phosphor pattern arranged in association with said electron source array and an accelerating electrode, the front substrate having an outer surface serving as a display surface,
further comprising a vacuum housing provided by opposing the inner surface of said back substrate to the inner surface of said front substrate to seal a sealing portion on edges of said substrates by a sealing material.

7. The flat panel display according to claim 6, wherein said back substrate is flat, said front substrate includes a frame glass integrally with its edge, and the inner surface of said back substrate is opposed to the inner surface of said front substrate to seal an end face of said frame glass and said back substrate through a sealing material.

8. The flat panel display according to claim 6, wherein said flat panel display is formed by disposing a frame glass separated from said back substrate and said front substrate on respective edges of said back substrate and said front substrate to make sealing with a sealing material between said back substrate, said front substrate, and said frame glass, and
said frame glass is made of glass material containing SiO₂ as its main component and 1 to 20 wt % of at least one selected from La, Sc, Y, Ce, Pr, Nd, Pm, Sm, Eu, Gd, Tb, Dy, Ho, Er, Tm, Yb, and Lu.

9. The flat panel display according to claim 6, wherein said flat panel display is formed by disposing a frame glass separated from said back substrate and said front substrate on respective edges of said back substrate and said front substrate to make sealing with a sealing material between said back substrate, said front substrate, and said frame glass, and
said frame glass is made of glass material containing SiO₂ as its main component and 1 to 20 wt % of at least one selected from La, Sc, Y, Ce, Pr, Nd, Pm, Sm, Eu, Gd, Tb, Dy, Ho, Er, Tm, Yb, and Lu, and showing a load, at which a crack occurrence rate is 50%, of 5000 mN or higher.

10. The flat panel display according to claim 6, wherein said flat panel display is formed by disposing a spacer for holding the interval between said back substrate and said front substrate within said vacuum housing formed by sealing said back substrate and said front substrate to seal said spacer, said back substrate, and said front substrate through a sealing material, and
said spacer is made of glass material containing SiO₂ as its main component and 1 to 20 wt % of at least one selected from La, Sc, Y, Ce, Pr, Nd, Pm, Sm, Eu, Gd, Tb, Dy, Ho, Er, Tm, Yb, and Lu.

11. The flat panel display according to claim 6, wherein said flat panel display is formed by disposing a spacer for holding the interval between said back substrate and said front substrate within said vacuum housing formed by sealing said back substrate and said front substrate to seal said spacer, said back substrate, and said front substrate through a sealing material, and
said spacer is made of glass material containing SiO₂ as its main component and 1 to 20 wt % of at least one selected from La, Sc, Y, Ce, Pr, Nd, Pm, Sm, Eu, Gd, Tb, Dy, Ho, Er, Tm, Yb, and Lu, and showing a load, at which a crack occurrence rate is 50%, of 5000 mN or higher.

12. The flat panel display according to claim 1, wherein said glass material has composition of 40 to 80 wt % SiO₂, 0 to 20 wt % B₂O₃, 0 to 30 wt % Al₂O₃, 5 to 20 wt % R₂₀ (R is alkali metal), 0 to 25 wt % R′O (R′ is alkaline earth metal), and 1 to 20 wt % Ln₂O₃ (Ln is at least one selected from La, Sc, Y, Ce, Pr, Nd, Pm, Sm, Eu, Gd, Tb, Dy, Ho, Er, Tm, Yb, and Lu) in oxide conversion.

13. The flat panel display according to claim 12, wherein said glass material contains a coloring component.

14. The flat panel display according to claim 12, wherein said glass material has a transition point of 450° C. or higher.

15. The flat panel display according to claim 12, wherein said glass material has a coefficient of thermal expansion of 60 to 90×10⁻⁷/° C.

16. The flat panel display according to claim 12, wherein said glass material has a Young's modulus of 80 Gpa or higher.

17. The flat panel display according to claim 1, wherein at least one of said two substrates or at least one of said back substrate and said front substrate has a thickness of 2.5 mm or smaller.

18. The flat panel display according to claim 1, further comprising a shatter-proof layer on at least one of said two substrates or at least one of said back substrate and said front substrate for reducing a flying amount of said glass material if it is broken.

19. The flat panel display according to claim 9, wherein said frame glass has all frame sides integrally formed.

20. The flat panel display according to claim 9, wherein said frame glass has frame sides bonded with a bonding material.
